(19) United States
(12) Patent Application Publication
(10) Pub. No.: US 2015/0271721 A1
(43) Pub. Date: Sep. 24, 2015

(54) METHOD AND APPARATUS FOR AN IMPROVED ACQUISITION MECHANISM

(71) Applicant: QUALCOMM Incorporated, San Diego, CA (US)

(72) Inventors: Harish VENKATACHARI, Sunnyvale, CA (US); Manjunath RAJU, San Diego, CA (US); Uttam PATTANAYAK, San Diego, CA (US); Valibabu SALADI, San Diego, CA (US); Sathish KRISHNAMOORTHY, Hyderabad (IN); Daisuke TERASAWA, Foster City, CA (US)

(73) Assignee: QUALCOMM Incorporated, San Diego, CA (US)

(21) Appl. No.: 14/223,538

(22) Filed: Mar. 24, 2014

(51) Int. Cl. H04W 36/06; H04W 48/18; H04J 11/00

(52) U.S. Cl. CPC H04W 36/06; H04J 11/0069; H04W 48/18

(57) ABSTRACT

The present disclosure presents a method and an apparatus for an improved acquisition mechanism at a user equipment (UE). For example, the disclosure presents a method for identifying a plurality of frequencies for camping by the UE, wherein each frequency of the plurality of frequencies is associated with a radio access technology (RAT), sorting the identified frequencies into one or more frequency groups based on a priority associated with each of the identified frequencies, searching a frequency group with a first highest priority to detect a cell for camping by the UE, and camping on a cell detected by the UE. As such, a method and an apparatus for an improved acquisition mechanism at a user equipment (UE) is disclosed.

### BACKGROUND

Aspects of the present disclosure relate generally to wireless communications and, more particularly, to a method and an apparatus for an improved acquisition mechanism.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

With rapid deployment of 3G/4G networks and the massive increase in the number of wireless devices, operators want control over which frequency a subscriber (e.g., user equipment) selects for camping on an operator's network. The camping of a UE on a cell may be defined as establishing a connection with a cell in a frequency band, and it may happen on initial acquisition after power up of the UE or after the UE enters an Out of Service (OOS) state. Generally, operators configure preferences for camping by defining the priority of frequency bands. However, the operators may like to configure preferences based on combination of a frequency band and a radio access technology (RAT).

As such, an improved acquisition mechanism is desired.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and an apparatus for an improved acquisition mechanism at a user equipment (UE). For example, the present disclosure presents an example method for identifying a plurality of frequencies for camping by the UE, wherein each frequency of the plurality of frequencies is associated with a radio access technology (RAT) and sorting the identified frequencies into one or more frequency groups based on a priority associated with each of the identified frequencies. The example method further comprises searching a frequency group with a first highest priority to detect a cell for camping by the UE and camping on a cell detected by the UE.

In an additional aspect, an apparatus for an improved acquisition mechanism at a user equipment (UE). The apparatus may include means for identifying a plurality of frequencies for camping by the UE wherein each frequency of the plurality of frequencies is associated with a radio access technology (RAT) and means for sorting the identified frequencies into one or more frequency groups based on a priority associated with each of the identified frequencies. The apparatus further comprises means for searching a frequency group with a first highest priority to detect a cell for camping by the UE and means for camping on a cell detected by the UE.

Moreover, the present disclosure presents an apparatus for an improved acquisition mechanism at a user equipment (UE). The apparatus may include a frequency identifying component to identify a plurality of frequencies for camping by the UE wherein each frequency of the plurality of frequencies is associated with a radio access technology (RAT) and a frequency sorting component to sort the identified frequencies into one or more frequency groups based on a priority associated with each of the identified frequencies. The apparatus further comprises a cell searching component to search a frequency group with a first highest priority to detect a cell for camping by the UE and a camping component to camp on a cell detected by the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example wireless system of aspects of the present disclosure;

FIG. 2 is a block diagram illustrating an example acquisition manager;

FIG. 3 is an example flow chart for an improved acquisition mechanism at a user equipment;

FIG. 4 is a block diagram illustrating aspects of a logical grouping of electrical components as contemplated by the present disclosure;

FIG. 5 is a block diagram illustrating an aspect of a computer device according to the present disclosure;

FIG. 6 is a block diagram illustrating an example of a hardware implementation for an apparatus employing a processing system;

FIG. 7 is a block diagram illustrating an example of a telecommunications system including a multi-mode UE configured to scan for service after being out-of-service, according to the described aspects;

FIG. 8 is a conceptual diagram illustrating an example of an access network;

FIG. 9 is a block diagram illustrating an example of a radio protocol architecture for user and control planes which may be used by a UE configured for an improved acquisition mechanism, according to the described aspects; and

FIG. 10 is a block diagram conceptually illustrating an example of a NodeB in communication with a UE in a telecommunications system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

An improved acquisition mechanism at a user equipment (UE) is disclosed. According to the present aspects, a plurality of frequencies for a UE to camp on is identified wherein the frequencies may belong to multiple radio access technologies (RAT). The frequencies are sorted into one or more groups based on priorities associated with the frequencies and the frequencies are searched based on the priorities to detect a cell for camping.

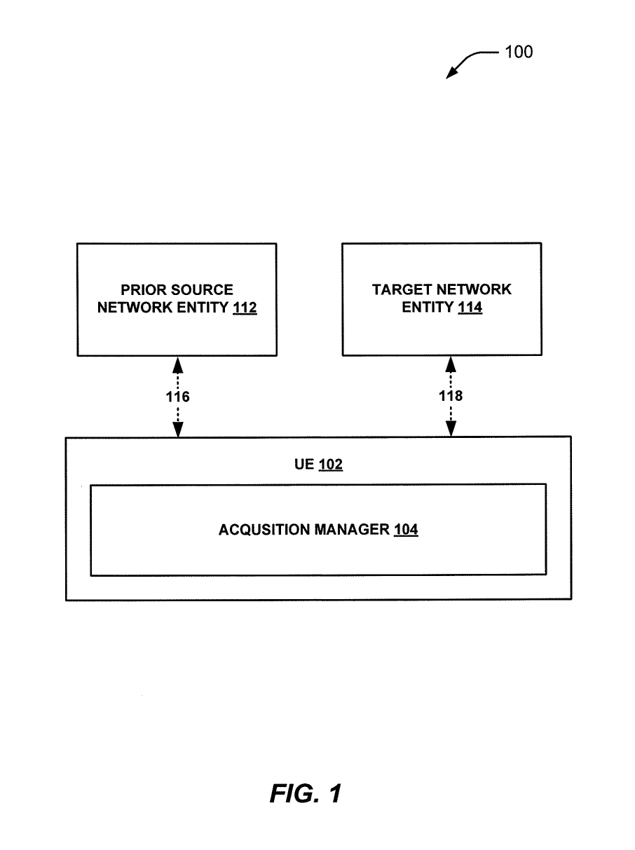

Referring to FIG. 1, a wireless communication system 100 is illustrated that facilitates an improved acquisition mechanism at a user equipment (UE) 102. System 100 includes user equipment (UE) 102 that may communicate with one or more network entities, for example, prior source network entity 112 and/or a target network entity 114, via one or more over-the-air links 116 and/or 118, respectively. In an aspect, UE 102 may be configured for an improved acquisition mechanism after power up of the UE and/or when the UE is trying to acquire a cell to camp on after entering an Out of Service (OOS) state. For example, the UE may enter OOS state due to mobility or loss of radio frequency (RF) coverage. In an aspect, for example, prior source network entity 112 may be a network entity that the UE was camped on prior to entering OOS state or prior to the UE turned OFF. Target network entity 114 may be a network entity the UE is trying to camp on (e.g., acquire a frequency) either on power up of the UE (e.g., turning ON the power of the UE) or when trying to camp on after entering an OOS state.

In an aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, prior source network entity 112 and/or target network entity 114, may include, but are not limited to, an access point, a base station (BS) or Node B or eNodeB, a macro cell, a femtocell, a pico cell, a relay, a peer-to-peer device, an authentication, authorization and accounting (AAA) server, a mobile switching center (MSC), etc. Additionally, network entities 112 and/or 114 may include one or more of any type of network component that can enable UE 102 to communicate and/or establish and maintain links 116 and/or 118 to respectively communicate with prior source network entity 112 and/or target network entity 114. In an example aspect, prior source network entity 112 and/or target network entity 114 may operate according to Global System for Mobile Communications (GSM), Code Division Multiple Access (CDMA), Wideband Code Division Multiple Access (W-CDMA), or Long Term Evolution (LTE) radio access technology (RAT) standard as defined in 3GPP/3GPP2 Specifications.

Furthermore, in an aspect, UE 102 may include an acquisition manager 104 which may be configured for an improved mechanism that includes identifying a plurality of frequencies for camping by the UE, wherein each frequency of the plurality of frequencies is associated with a radio access technology (RAT), sorting the identified frequencies into one or more frequency groups based on a priority associated with each of the identified frequencies, searching a frequency group with a first highest priority to detect a cell for camping by the UE, and camping on a cell detected by the UE.

In an additional or optional aspect, UE 102 and/or acquisition manager 104 may be further configured to create an acquisition database (ACQ DB) with each of the one or more frequency groups wherein the ACQ DB comprises a listing of cells for each of the one or more frequency groups the UE has successfully camped on previously and search the ACQ DB of a frequency group with the first highest priority to detect a cell for camping.

In an aspect, for example, UE 102 and/or acquisition manager 104 may be configured to include a frequency identifying component, a frequency sorting component, a cell searching component, and/or a camping component. In an additional or optional aspect, UE 102 and/or acquisition manager 104 may be further configured to optionally include an acquisition database creating component and/or an acquisition database searching component.

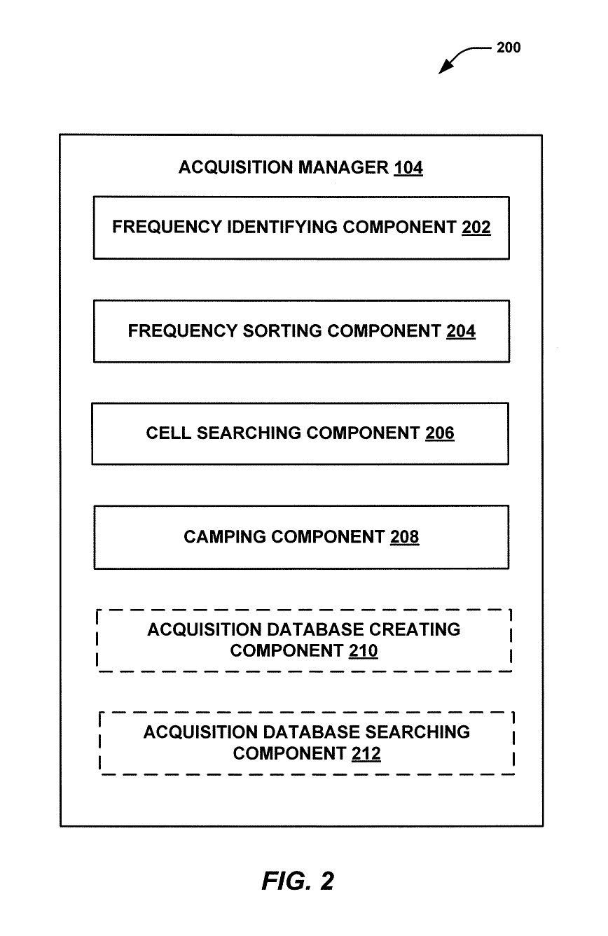

Referring to FIG. 2, an example acquisition manager 104 in aspects of the present disclosure is illustrated.

In an aspect, acquisition manager 104, for example, of UE 102, may be configured to include a frequency identifying component 202, a frequency sorting component 204, a cell searching component 206, and/or a camping component 208.

In an aspect, frequency identifying component 202 may be configured to identify a plurality of frequencies for camping by the UE. For example, UE 202 and/or frequency identifying component 202 may scan for frequencies for camping when the UE is powered or turned ON and/or recovering from an Out of Service (00S) state. During scanning, frequency identifying component 202 may identify one or more frequencies that the UE may potentially camp on for service. In an additional aspect, the identified frequencies may be associated with a same radio access technology (RAT) or different RATs. For example, in an aspect, frequency identifying component 202 may identify frequencies F1, F2, and/or F3 during the scanning. In an example aspect, F1 may belong to RAT 1, F2 may belong to RAT 2, and/or F3 may belong to RAT 3. In an additional or optional aspect, for example, F1 and F2 may belong to RAT 1 and/or F3 may belong to RAT 2. In an aspect, the RAT to which a frequency belongs is generally configured by a network operator, for example, target network entity 114.

In an aspect, the RATs may be selected from a list that may include Global System for Mobile Communications (GSM), Code Division Multiple Access (CDMA), Wideband Code Division Multiple Access (W-CDMA), Long Term Evolution (LTE), and other RAT as defined in the 3GPP Specifications.

In an aspect, frequency sorting component 204 may be configured to sort the identified frequencies into one or more frequency groups based on a priority associated with each of the identified frequencies. The sorting of the frequencies into groups may be based on a priority associated with each of the frequencies. In an aspect, for example, the priorities associated with each of the frequencies may be assigned by a network operator, e.g., target network entity 114. A network operator may assign priorities to the frequencies to control the order in which the UE searches for frequencies for camping.

In an example aspect, frequency sorting component 204 may sort frequencies, for example, F1, F2, F3, F4, F5, and/or F6 into one or more frequency groups, for example, G1, G2, and/or G3. The sorting of the frequencies into groups may be based on priorities assigned by the network operator. For example:

G1→F1,F2;G2→F3,F4,F5;G3→F6

In an aspect, cell searching component 206 may be configured to search a frequency group with a first highest priority to detect a cell for camping by the UE. For example, in an aspect, cell searching component 206 may search the highest priority group, for example, G1, to detect a cell for camping by UE 102. For example, cell searching component 206 may search frequencies F1 and F2 to detect a cell for camping. In an aspect, F1 and F2 may be sorted in G1 based on their priorities within the group. For example, F1 is configured with the first highest priority in G1 and F2 is configured with the next highest priority in G1.

In an aspect, when cell searching component 206 is searching for a cell for camping, the cell, for example, frequency F1, may have to meet certain requirements for camping which may be defined in 3GPP Specifications. When cell searching component 206 determines that F1 is not suitable for camping, cell searching component 206 may search for a cell associated with frequency F2 for camping. The searching for a suitable cell to camp proceeds until the UE finds a cell suitable for camping or there are no more frequencies for searching.

In an aspect, when cell searching component 206 finishes searching all the frequencies in the highest priority group (e.g., first highest priority group) and fails to find a suitable cell for camping, cell searching component 206 may continue searching for cells to camp in the next highest priority group, for example, G2.

In an aspect, camping component 208 may be configured to camp on a cell detected by the UE. For example, in an aspect, camping component 208 is configured to camp UE 101 on a cell detected by cell searching component 206.

In an additional or optional aspect, an acquisition database (ACQ DB) creating component 210 may be configured to create an acquisition database (ACQ DB) with one or more frequency groups. For example, in an aspect, ACQ DB creating component may create a database (not shown) which may include the frequency groups, for example, G1, G2, and/or G3. In an additional aspect, the ACQ DB comprises a listing of cells for each of the one or more frequency groups the UE has successfully camped on previously.

An example of the ACQ DB is shown below:

ACQ DB G1→F1;ACQ DB G2→F4,F5

The above example shows an ACQ DB that is created which may include frequency F1 for G1 and frequencies F4 and F5 for G2 which may be based on UE 102 successfully camping on frequencies F1, F2 and F3 previously (e.g., in the past, prior to the UE being turned ON or prior to the UE entering an OOS state).

In an additional or optional aspect, an acquisition database searching component 212 may be configured to search the ACQ DB of a frequency group with the first highest priority to detect a cell for camping. For example, in an aspect, acquisition database searching component 212 may search the ACQ DB G1 to detect a frequency for camping as G1 is the frequency group with highest priority. Additionally, acquisition database searching component 212 may search ACQ DB G2 if acquisition database searching component 212 does not find a frequency in ACQ DB G1 for camping.

In an aspect, UE 102 may search for frequencies in the ACQ DB prior to performing a full search, as the UE may acquire a frequency for camping by searching of ACQ DB relatively faster than performing a full search. The aspects described above has the advantage of relatively faster camping resulting in getting out of OOS state.

In an aspect, acquisition database searching component 212 may search for a cell listed in the ACQ DB at an Absolute Radio Frequency Channel Number (ARFCN). In an additional or optional aspect, cell searching component 206 may perform a full search on primary scrambling codes (PSC) at the ARFCN.

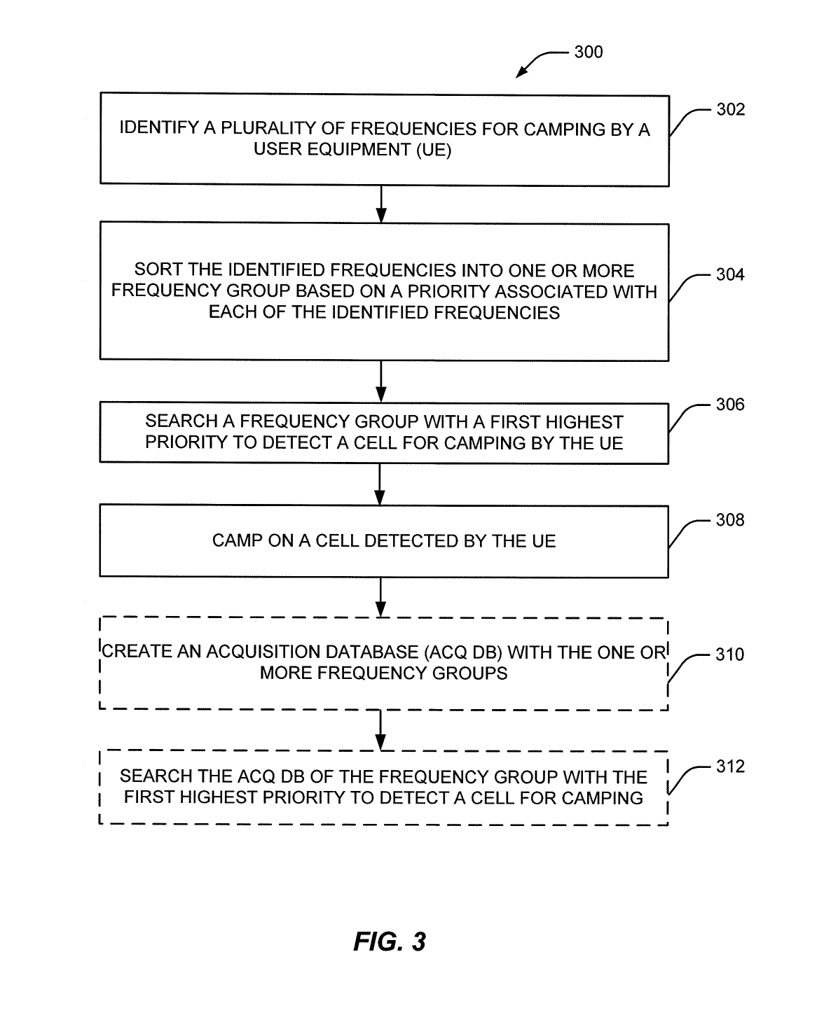

Referring to FIG. 3, a method 300 may be performed by UE 102 of FIG. 1, for an improved acquisition mechanism, according to the described aspects. In an aspect, acquisition manager 104, frequency identifying component 202, frequency sorting component 204, cell searching component 206, camping component 208, acquisition database creating component 210, and/or acquisition database searching component 212, all of FIG. 2, may be configured to perform aspects of method 300.

At 302, method 300 includes identifying a plurality of frequencies for camping by the UE. In an aspect, for example, acquisition manager 104 and/or frequency identifying component 202 may be configured to identify a plurality of frequencies for camping by the UE. For example, the UE may identify the frequencies by scanning the surrounding wireless environment using techniques known in the art. In an additional aspect, the frequencies identified by frequency identifying component 202 may belong to different RATs. For example, frequency identifying component 202 may identify frequencies, F1 and F2, which may belong to two different RATs, e.g., F1 may belong W-CDMA and/or F2 may belong to LTE.

At 304, method 300 includes sorting the identified frequencies into one or more frequency groups based on a priority associated with each of the identified frequencies. In an aspect, acquisition manager 104 and/or frequency sorting component 204 may be configured to sort the identified frequencies into various frequency groups as described above in relating to FIG. 2. In an aspect, the sorting of the identified frequencies into various groups may be achieved based on the priorities associated with each of the frequencies. In an additional or optional aspect, the priorities of the frequencies may be configured by the network operators.

At 306, method 300 includes searching a frequency group with a first highest priority to detect a cell for camping by the UE. For example, in an aspect, acquisition manager 104 and/or cell searching component 206 may be configured to search the frequency group with the highest priority, e.g., group G1, to detect a cell for camping by UE 102. In an additional aspect, the frequencies within a group may also be ordered based on a priority, e.g., configured by the network operator, as well.

At 308, method 300 includes camping on a cell detected by the UE. For example, in an aspect, acquisition manager 104 and/or camping component 208 may be configured to camp on a cell detected by the UE.

At 310, method 300, in an optional aspect, includes creating an acquisition database (ACQ DB) with the one or more frequency groups. For example, in an aspect, acquisition manager 104 and/or acquisition database creating component 210 may be configured to create an ACQ DB which may include the sorted frequency groups. In an aspect, the ACQ DB may include a listing of cells for the one or more frequency groups the UE has successfully camped on previously

At 312, method 300 includes searching the ACQ DB of a frequency group with the first highest priority to detect a cell for camping. For example, in an aspect, acquisition manager 104 and/or acquisition database searching component 212 may search the ACQ DB that stores the frequency groups to detect a cell for camping. In an aspect, the searching may be performed on a per group (and per frequency) basis based on the priority of the group (and frequency). The searching for suitable cells in the ACQ DB may be performed prior to performing the full search of the frequencies in the frequency groups.

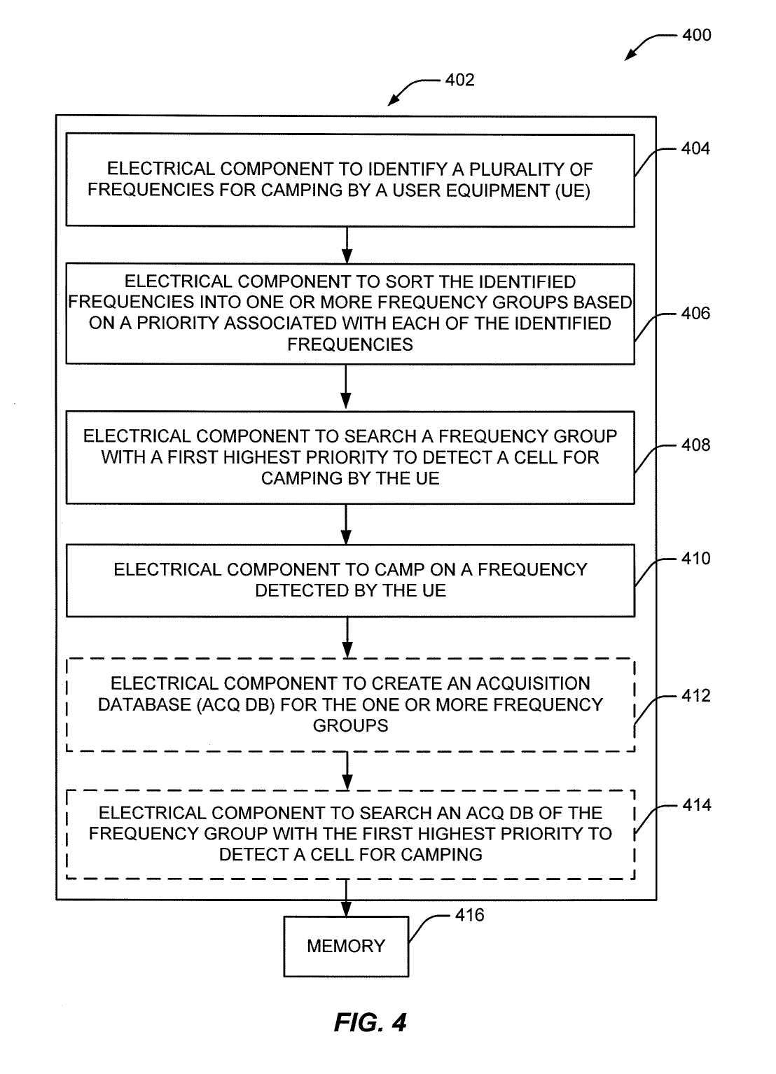

Referring to FIG. 4, an example system 400 is displayed for an improved acquisition mechanism. For example, system 400 can reside at least partially within UE 102 (FIG. 1). It is to be appreciated that system 400 is represented as including functional blocks, which can be functional blocks that represent functions implemented by a processor, software, or combination thereof (for example, firmware). System 400 includes a logical grouping 402 of electrical components that can act in conjunction. For instance, logical grouping 402 can include an electrical component 404 to identify a plurality of frequencies for camping by the UE, wherein each frequency of the plurality of frequencies is associated with a radio access technology (RAT). In an aspect, for example, electrical component 404 may comprise frequency identifying component 202 (FIG. 2).

In an aspect, logical grouping 402 can include an electrical component 406 for sorting the identified frequencies into one or more frequency groups based on a priority associated with each of the identified frequencies. In an aspect, for example, electrical component 406 may comprise frequency sorting component 204 (FIG. 2).

Additionally, logical grouping 402 can include an electrical component 408 for searching a frequency group with a first highest priority to detect a cell for camping by the UE. In an aspect, for example, electrical component 408 may comprise cell searching component 206 (FIG. 2).

Further, logical grouping 402 can include an electrical component 410 for camping on a cell detected by the UE. In an aspect, for example, electrical component 410 may comprise camping component 210 (FIG. 2).

In an additional or optional aspect, logical grouping 402 can include an electrical component 412 for creating an acquisition database (ACQ DB) with the one or more frequency groups. In an aspect, for example, electrical component 412 may acquisition database creating component 210 (FIG. 2). In an additional aspect, the ACQ DB may comprise a listing of cells for the one or more frequency groups the UE has successfully camped on previously.

In a further additional or optional aspect, logical grouping 402 can include an electrical component 414 for searching the ACQ DB of a frequency group with the first highest priority to detect a cell for camping. In an aspect, for example, electrical component 414 may comprise acquisition database searching component 212 (FIG. 2).

In an aspect, system 400 can include a memory 416 that retains instructions for executing functions associated with the electrical components 404, 406, 408, 410, 412, and 414, and stores data used or obtained by the electrical components 404, 406, 408, 410, 412, and 414, etc. While shown as being external to memory 416, it is to be understood that one or more of the electrical components 404, 406, 408, 410, 412, and 414 can exist within memory 416. In one example, electrical components 404, 406, 408, 410, 412, and 414 can comprise at least one processor, or each electrical component 404, 406, 408, 410, 412, and 414 can be a corresponding module of at least one processor. Moreover, in an additional or alternative example, electrical components 404, 406, 408, 410, 412, and 414 can be a computer program product including a computer readable medium, where each electrical component 404, 406, 408, 410, 412, and 414 can be corresponding code.

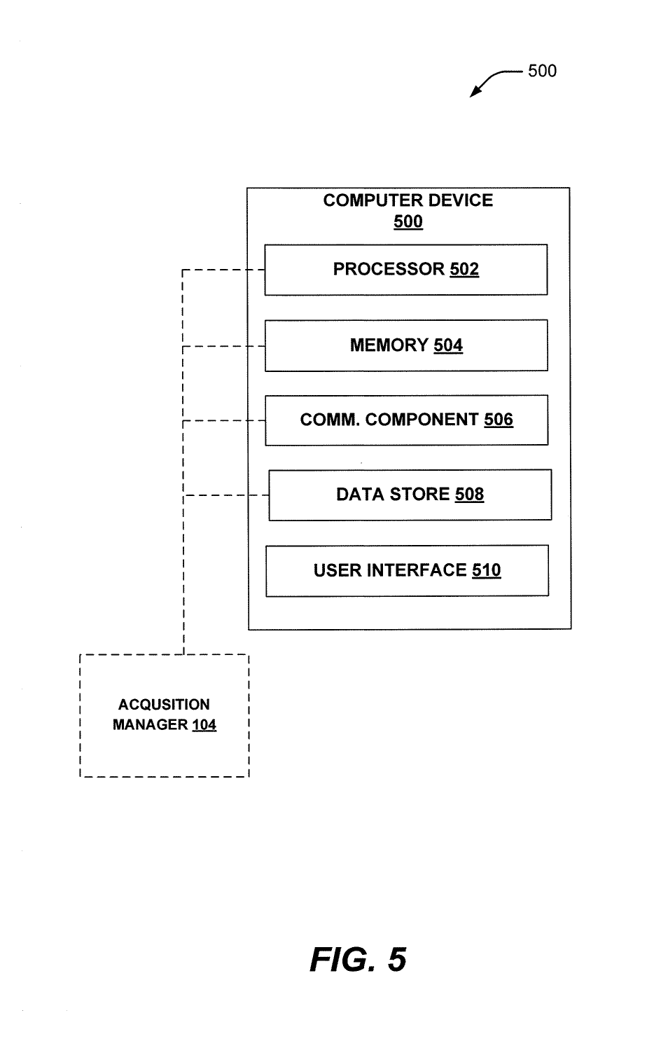

Referring to FIG. 5, an aspect of a computer device 500 may be specially programmed or configured to perform the respective functions described herein of any one of the various components of acquisition manager 104. For example, in one aspect, computer device 500 may include acquisition manager 104, frequency identifying component 202, frequency sorting component 204, cell searching component 206, camping component 208, acquisition database creating component 210, and/or acquisition database searching component 212 as shown in FIGS. 1-4.

Computer device 500 includes a processor 502 specially configured to carry out processing functions associated with one or more of components and functions described herein. Processor 502 can include a single or multiple set of processors or multi-core processors. Moreover, processor 502 can be implemented as an integrated processing system and/or a distributed processing system. For example, processor 502 may be configured to execute the described functions of acquisition manager 104, frequency identifying component 202, frequency sorting component 204, cell searching component 206, camping component 208, acquisition database creating component 210, and/or acquisition database searching component 212, as shown in FIGS. 1-4.

Computer device 500 further includes a memory 504, such as for storing data used herein and/or local versions of applications and/or instructions or code being executed by processor 502, such as to perform the respective functions of the respective entities described herein. Memory 504 can include any type of memory usable by a computer, such as random access memory (RAM), read only memory (ROM), tapes, magnetic discs, optical discs, volatile memory, non-volatile memory, and any combination thereof. For example, memory 504 may be configured to store frequencies, groups, priorities, and/or ACQ DB related to an improved acquisition mechanism as described herein with respect to acquisition manager 104.

Further, computer device 500 includes a communications component 506 that provides for establishing and maintaining communications with one or more parties utilizing hardware, software, and services as described herein. Communications component 506 may carry communications between components on computer device 500, as well as between computer device 500 and external devices, such as devices located across a communications network and/or devices serially or locally connected to computer device 500. For example, communications component 506 may include one or more buses, and may further include transmit chain components and receive chain components associated with a transmitter and receiver, respectively, or a transceiver, operable for interfacing with external devices. For example, communications component 506 may be configured to perform the communications functions described herein of acquisition manager 104 and/or components of the acquisition manager 104.

Additionally, computer device 500 may further include a data store 508, which can be any suitable combination of hardware and/or software, that provides for mass storage of information, databases, and programs employed in connection with aspects described herein. For example, data store 508 may be a data repository for applications not currently being executed by processor 502. For example, data store 508 may be configured to store frequencies, groups, priorities, and/or ACQ DB information related to an improved acquisition mechanism as described herein with respect to acquisition manager 104.

Computer device 500 may additionally include a user interface component 510 operable to receive inputs from a user of computer device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof. For example, user interface component 510 may be configured to receive user input from acquisition manager 104 (e.g., frequencies, groups, priorities, etc.).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. A storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

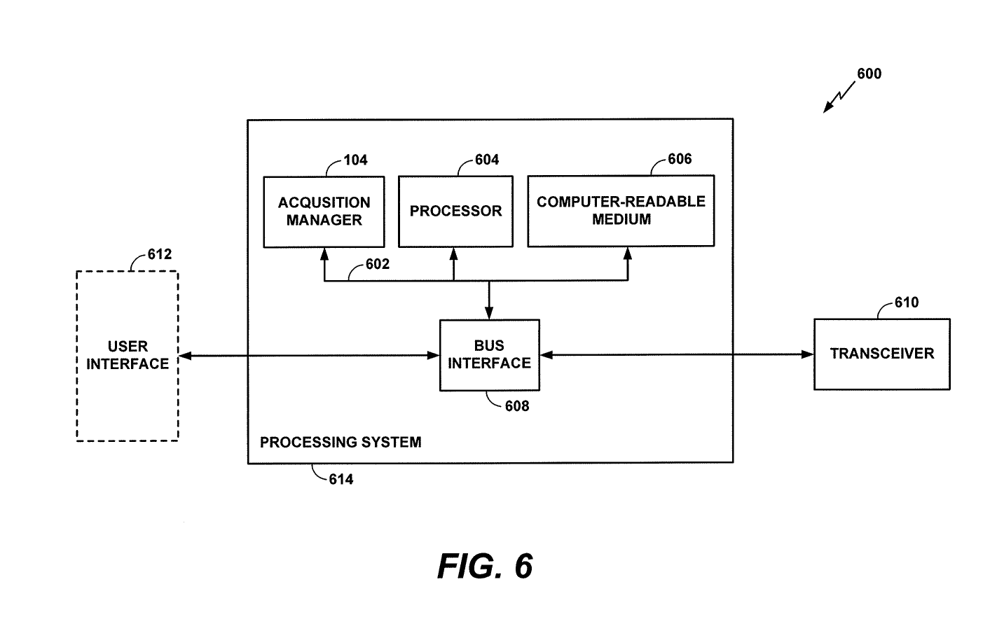

FIG. 6 is a block diagram illustrating an example of a hardware implementation for an apparatus 600, for example, including acquisition manager 104 (FIGS. 1-2), employing a processing system 614 for carrying out aspects of the present disclosure, such as a method for transmitting symbol files. In this example, the processing system 614 may be implemented with bus architecture, represented generally by a bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, and one or more components described herein, such as, but not limited to, acquisition manager 104, frequency identifying component 202, frequency sorting component 204, cell searching component 206, camping component 208, acquisition database creating component 210, and/or acquisition database searching component 212 (FIGS. 1-2).

The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

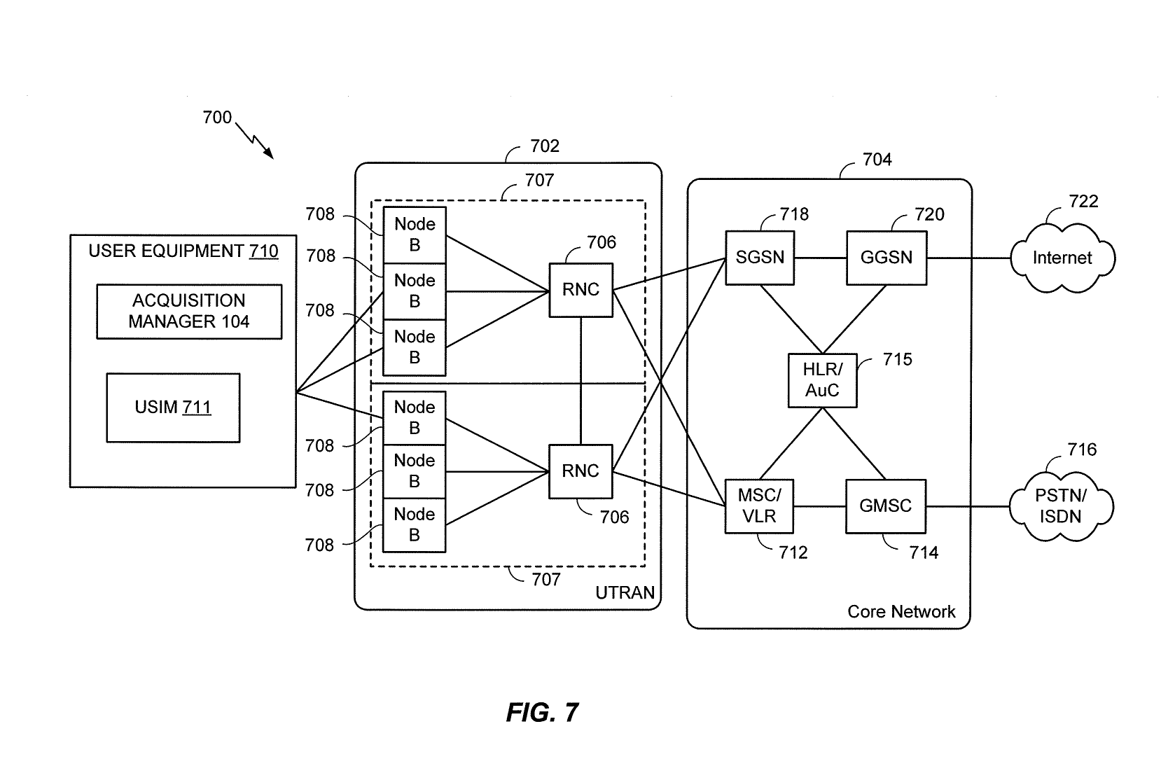

Referring to FIG. 7, by way of example and without limitation, the aspects of the present disclosure are presented with reference to a UMTS system 700 employing a W-CDMA air interface, in which UE 102 of FIG. 1 may operate. A UMTS network includes three interacting domains: a Core Network (CN) 704, a UMTS Terrestrial Radio Access Network (UTRAN) 702, and User Equipment (UE) 710. In an aspect, UE 710 may be UE 102 of FIG. 1, and include acquisition manager (104), also of FIG. 1.

In this example, the UTRAN 702 provides various wireless services including telephony, video, data, messaging, broadcasts, and/or other services. The UTRAN 702 may include a plurality of Radio Network Subsystems (RNSs) such as an RNS 707, each controlled by a respective Radio Network Controller (RNC) such as an RNC 706. Here, the UTRAN 702 may include any number of RNCs 706 and RNSs 407 in addition to the RNCs 706 and RNSs 707 illustrated herein. The RNC 706 is an apparatus responsible for, among other things, assigning, reconfiguring and releasing radio resources within the RNS 707. The RNC 706 may be interconnected to other RNCs (not shown) in the UTRAN 702 through various types of interfaces such as a direct physical connection, a virtual network, or the like, using any suitable transport network.

Communication between a UE 710 and a Node B 708 may be considered as including a physical (PHY) layer and a medium access control (MAC) layer. Node B 708 may be prior source network entity 112 and/or target network entity 114 of FIG. 1. Further, communication between a UE 710 and an RNC 706 by way of a respective Node B 708 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 25.331 incorporated herein by reference.

The geographic region covered by the RNS 707 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 708 are shown in each RNS 707; however, the RNSs 707 may include any number of wireless Node Bs. The Node Bs 708 provide wireless access points to a CN 704 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 710 may further include a universal subscriber identity module (USIM) 711, which contains a user's subscription information to a network. For illustrative purposes, one UE 710 is shown in communication with a number of the Node Bs 708. The DL, also called the forward link, refers to the communication link from a Node B 708 to a UE 710, and the UL, also called the reverse link, refers to the communication link from a UE 710 to a Node B 708.

The CN 704 interfaces with one or more access networks, such as the UTRAN 702. As shown, the CN 704 is a GSM core network. However, as those skilled in the art will recognize, the various concepts presented throughout this disclosure may be implemented in a RAN, or other suitable access network, to provide UEs with access to types of CNs other than GSM networks.

The CN 704 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 704 supports circuit-switched services with a MSC 712 and a GMSC 717. In some applications, the GMSC 717 may be referred to as a media gateway (MGW). One or more RNCs, such as the RNC 706, may be connected to the MSC 712. The MSC 712 is an apparatus that controls call setup, call routing, and UE mobility functions. The MSC 712 also includes a VLR that contains subscriber-related information for the duration that a UE is in the coverage area of the MSC 712. The GMSC 717 provides a gateway through the MSC 712 for the UE to access a circuit-switched network 716. The GMSC 717 includes a home location register (HLR) 715 containing subscriber data, such as the data reflecting the details of the services to which a particular user has subscribed. The HLR is also associated with an authentication center (AuC) that contains subscriber-specific authentication data. When a call is received for a particular UE, the GMSC 717 queries the HLR 715 to determine the UE's location and forwards the call to the particular MSC serving that location.

The CN 704 also supports packet-data services with a serving GPRS support Node (SGSN) 718 and a gateway GPRS support Node (GGSN) 720. GPRS, which stands for General Packet Radio Service, is designed to provide packet-data services at speeds higher than those available with standard circuit-switched data services. The GGSN 720 provides a connection for the UTRAN 702 to a packet-based network 722. The packet-based network 722 may be the Internet, a private data network, or some other suitable packet-based network. The primary function of the GGSN 720 is to provide the UEs 710 with packet-based network connectivity. Data packets may be transferred between the GGSN 720 and the UEs 710 through the SGSN 718, which performs primarily the same functions in the packet-based domain as the MSC 712 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 708 and a UE 710. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 410 provides feedback to the Node B 408 over the HS-DPCCH to indicate whether it correctly decoded a packet on the downlink.

HS-DPCCH further includes feedback signaling from the UE 410 to assist the Node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the Node B 408 and/or the UE 410 may have multiple antennas supporting MIMO technology. The use of MIMO technology enables the Node B 408 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 710 to increase the data rate or to multiple UEs 710 to increase the overall system capacity. This is achieved by spatially precoding each data stream and then transmitting each spatially precoded stream through a different transmit antenna on the downlink. The spatially precoded data streams arrive at the UE(s) 710 with different spatial signatures, which enables each of the UE(s) 710 to recover the one or more the data streams destined for that UE 710. On the uplink, each UE 710 may transmit one or more spatially precoded data streams, which enables the Node B 708 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

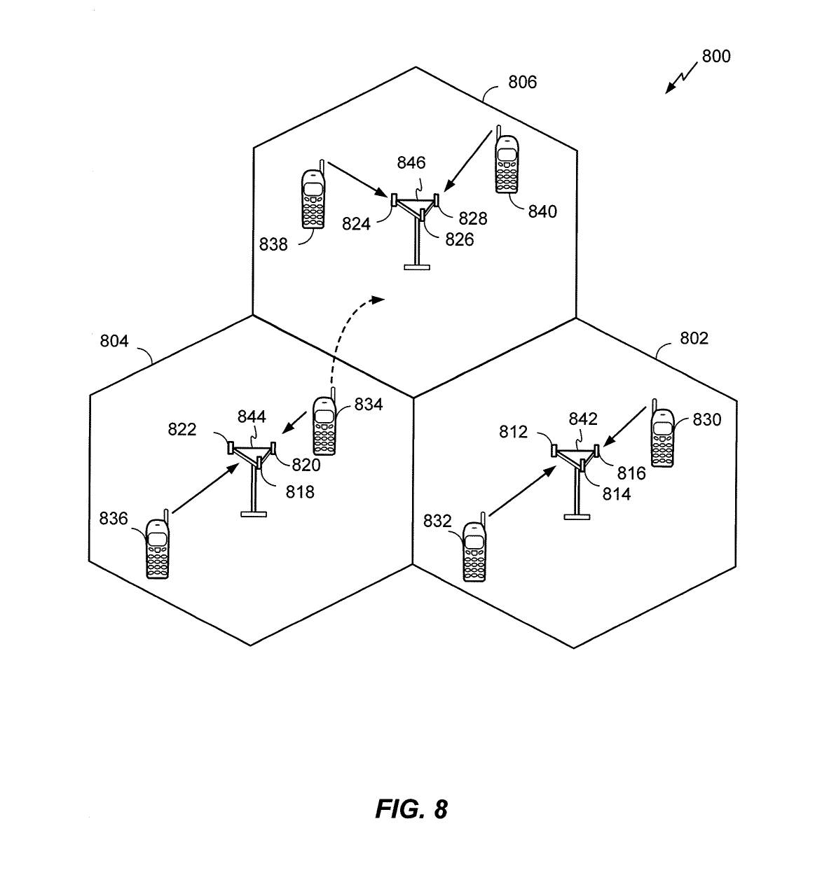

Referring to FIG. 8, an access network 800, in which UE 102 of FIG. 1 may operate, in UTRAN architecture is illustrated. The multiple access wireless communication system includes multiple cellular regions (cells), including cells 802, 804, and 806, each of which may include one or more sectors.

The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a CN 404 (see FIG. 4) for all the UEs 830, 832, 834, 836, 838, 840 in the respective cells 802, 804, and 806. In an aspect, UEs 830, 832, 834, 836, 838, and/or 840 may be UE 102 of FIG. 1, and Node Bs 842, 844, and/or 846 may be prior source network entity 112 and/or target network entity 114 of FIG. 1.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 706 (see FIG. 7), or at another suitable Node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set).

The modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented with reference to FIG. 7.

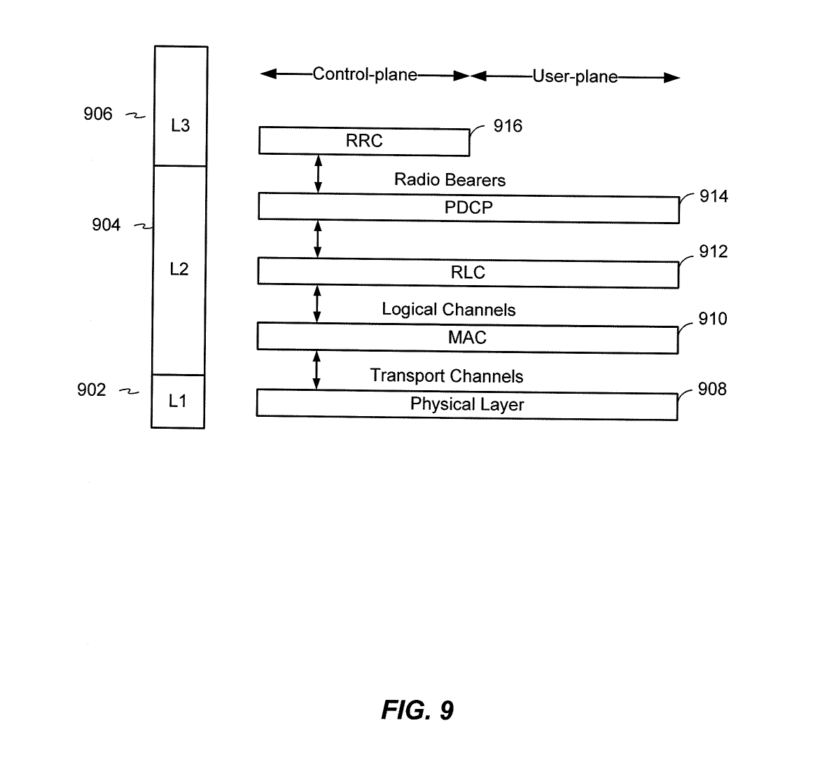

Referring to FIG. 9, an example radio protocol architecture 900 relates to the user plane 902 and the control plane 904 of a user equipment (UE), such as UE 102 of FIG. 1, and/or a network entities 112/114 of FIG. 1. The radio protocol architecture 900 for the UE and Node B is shown with three layers: Layer 1 902, Layer 2 904, and Layer 3 906. Layer 1 902 is the lowest lower and implements various physical layer signal processing functions. As such, Layer 1 902 includes the physical layer 908. Layer 2 (L2 layer) 904 is above the physical layer 908 and is responsible for the link between the UE and Node B over the physical layer 908. Layer 3 (L3 layer) 906 includes a radio resource control (RRC) sublayer 916. The RRC sublayer 916 handles the control plane signaling of Layer 3 between the UE and the UTRAN.

In the user plane, the L2 layer 904 includes a media access control (MAC) sublayer 910, a radio link control (RLC) sublayer 912, and a packet data convergence protocol (PDCP) 914 sublayer, which are terminated at the Node B on the network side. Although not shown, the UE may have several upper layers above the L2 layer 904 including a network layer (e.g., IP layer) that is terminated at a PDN gateway on the network side, and an application layer that is terminated at the other end of the connection (e.g., far end UE, server, etc.).

The PDCP sublayer 914 provides multiplexing between different radio bearers and logical channels. The PDCP sublayer 914 also provides header compression for upper layer data packets to reduce radio transmission overhead, security by ciphering the data packets, and handover support for UEs between Node Bs. The RLC sublayer 912 provides segmentation and reassembly of upper layer data packets, retransmission of lost data packets, and reordering of data packets to compensate for out-of-order reception due to hybrid automatic repeat request (HARQ). The MAC sublayer 910 provides multiplexing between logical and transport channels. The MAC sublayer 910 is also responsible for allocating the various radio resources (e.g., resource blocks) in one cell among the UEs. The MAC sublayer 910 is also responsible for HARQ operations.

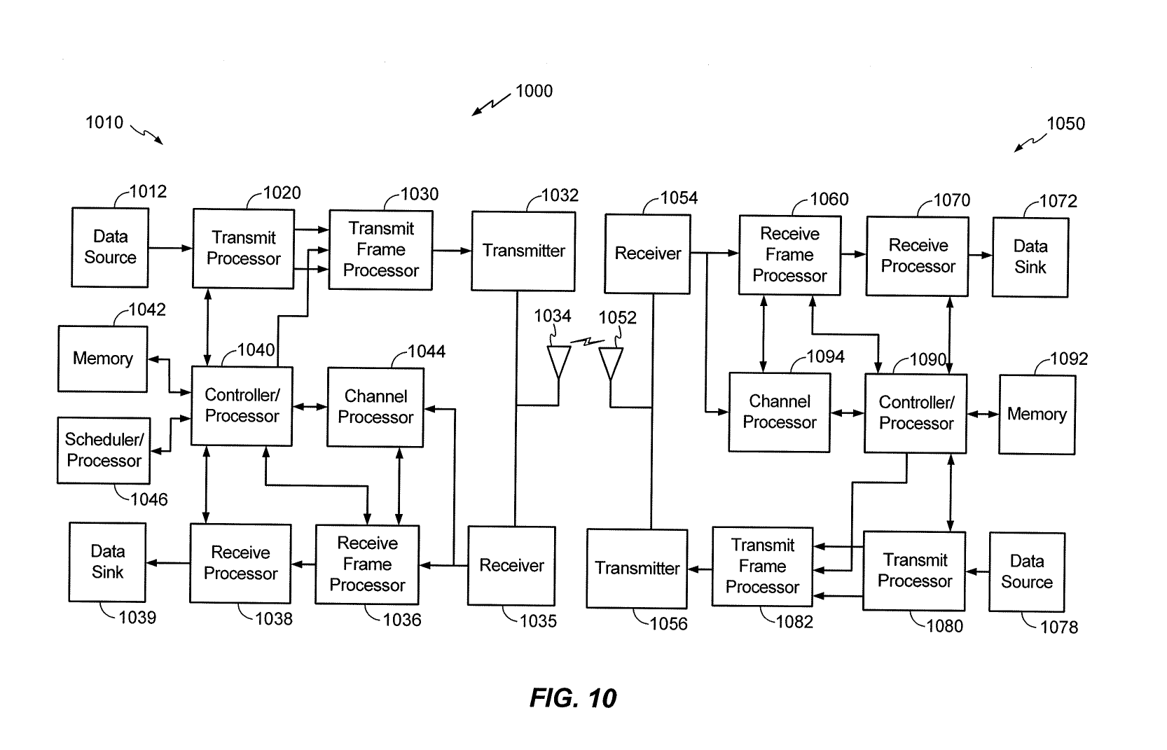

FIG. 10 is a block diagram of a Node B 1010 in communication with a UE 1050, where UE 1050 may be UE 102 of FIG. 1 and/or UE 710 of FIG. 7, and Node B 1010 may be network entity 112/114 of FIG. 1. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and de-spreads the symbols, and then determines the most likely signal constellation points transmitted by the Node B 1010 based on the modulation scheme. These soft decisions may be based on channel estimates computed by the channel processor 1094. The soft decisions are then decoded and de-interleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

What is claimed is:

1. A method for an improved acquisition mechanism at a user equipment (UE), comprising:
identifying a plurality of frequencies for camping by the UE, wherein each frequency of the plurality of frequencies is associated with a radio access technology (RAT);
sorting the identified frequencies into one or more frequency groups based on a priority associated with each of the identified frequencies;
searching a frequency group with a first highest priority to detect a cell for camping by the UE; and
camping on a cell detected by the UE.

2. The method of claim 1, further comprising:
creating an acquisition database (ACQ DB) with the one or more frequency groups, wherein the ACQ DB comprises a listing of cells for the one or more frequency groups the UE has successfully camped on previously; and
searching the ACQ DB of a frequency group with the first highest priority to detect a cell for camping.

3. The method of claim 2, wherein the searching the ACQ DB comprises searching for a cell in the ACQ DB at an Absolute Radio Frequency Channel Number (ARFCN).

4. The method of claim 3, wherein the searching the frequency group comprises performing a full search on Primary Scrambling Codes (PSC) at the ARFCN.

5. The method of claim 1, further comprising:
searching a frequency group with a second highest priority until a cell for camping is detected by the UE.

6. The method of claim 1, wherein the RAT is selected from a list comprising a Global System for Mobile Communications (GSM) RAT, a Code Division Multiple Access (CDMA) RAT, Wideband Code Division Multiple Access (W-CDMA) RAT, and a Long Term Evolution (LTE) RAT.

7. The method of claim 1, wherein a priority associated with an identified frequency is configured by a network operator.

8. The method of claim 1, wherein the improved frequency acquisition mechanism is triggered on power up of the UE or while searching for a cell to recover from an Out of Service (OOS) state.

9. An apparatus for an improved acquisition mechanism at a user equipment (UE), comprising:
means for identifying a plurality of frequencies for camping by the UE, wherein each frequency of the plurality of frequencies is associated with a radio access technology (RAT);
means for sorting the identified frequencies into one or more frequency groups based on a priority associated with each of the identified frequencies;
means for searching a frequency group with a first highest priority to detect a cell for camping by the UE; and
means for camping on a cell detected by the UE.

10. The apparatus of claim 9, further comprising:
means for creating an acquisition database (ACQ DB) with the one or more frequency groups, wherein the ACQ DB comprises a listing of cells for the one or more frequency groups the UE has successfully camped on previously; and
means for searching the ACQ DB of a frequency group with the first highest priority to detect a cell for camping.

11. The apparatus of claim 9, further comprising:
means for searching a frequency group with a second highest priority until a cell for camping is detected by the UE.

12. The apparatus of claim 9, wherein the RAT is selected from a list comprising a Global System for Mobile Communications (GSM) RAT, a Code Division Multiple Access (CDMA) RAT, Wideband Code Division Multiple Access (W-CDMA) RAT, and a Long Term Evolution (LTE) RAT.

13. An apparatus for an improved acquisition mechanism at a user equipment (UE), comprising:
a frequency identifying component to identify a plurality of frequencies for camping by the UE, wherein each frequency of the plurality of frequencies is associated with a radio access technology (RAT);
a frequency sorting component to sort the identified frequencies into one or more frequency groups based on a priority associated with each of the identified frequencies;
a cell searching component to search a frequency group with a first highest priority to detect a cell for camping by the UE; and
a camping component to camp on a cell detected by the UE.

14. The apparatus of claim 13, further comprising:
an acquisition database (ACQ DB) creating component to create an ACQ DB with the one or more frequency groups, wherein the ACQ DB comprises a listing of cells for the one or more frequency groups the UE has successfully camped on previously; and
an acquisition database (ACQ DB) searching component to search the ACQ DB of a frequency group with the first highest priority to detect a cell for camping.

15. The apparatus of claim 14, wherein the ACQ DB searching component is configured to search for a cell in the ACQ DB at an Absolute Radio Frequency Channel Number (ARFCN).

16. The apparatus of claim 15, wherein the cell searching component is configured to perform a full search on Primary Scrambling Codes (PSC) at the ARFCN.

17. The apparatus of claim 13, wherein the cell searching component is further configured to search a frequency group with a second highest priority until a cell for camping is detected by the UE.

18. The apparatus of claim 13, wherein the RAT is selected from a list comprising a Global System for Mobile Communications (GSM) RAT, a Code Division Multiple Access (CDMA) RAT, Wideband Code Division Multiple Access (W-CDMA) RAT, and a Long Term Evolution (LTE) RAT.

19. The apparatus of claim 13, wherein a priority associated with an identified frequency is configured by a network operator.

20. The apparatus of claim 13, wherein the improved frequency acquisition mechanism is triggered on power up of the UE or while searching for a cell to recover from an Out of Service (OOS) state.
